(19) United States
(12) Patent Application Publication
(10) Pub. No.: US 2024/0157588 A1
(43) Pub. Date: May 16, 2024

(54) HANDLE, SHAVER, HAIR DRYER, HAIR STYLING IRON, HAIRBRUSH, AND EYELASH CURLER

(71) Applicant: Murata Manufacturing Co., Ltd., Kyoto (JP)

(72) Inventors: Shinji OKAWA, Kyoto (JP); Koji OSAKI, Kyoto (JP)

(21) Appl. No.: 18/422,701

(22) Filed: Jan. 25, 2024

Related U.S. Application Data
(63) Continuation of application No. PCT/JP2022/028681, filed on Jul. 26, 2022.

(30) Foreign Application Priority Data
Jul. 27, 2021 (JP) 2021-122437

(51) Int. Cl. B26B 19/38

(52) U.S. Cl. CPC B26B 19/382

(57) ABSTRACT

A handle includes a casing grippable by a user with a hand and fingers. The casing incorporates a first vibrating body and a second vibrating body. A control device is capable of generating a first sense of force in a first direction by controlling a vibration pattern of the first vibrating body. The control device is capable of generating a second sense of force in a second direction by controlling a vibration pattern of the second vibrating body. Then, the control device can control the vibration pattern of the first vibrating body and the second vibrating body so that the first direction and the second direction are different directions and an imaginary line headed toward the first direction from the first vibrating body and an imaginary line headed toward the second direction from the second vibrating body are not located on the same straight line.

### CROSS REFERENCE TO RELATED APPLICATION

This is a continuation of International Application No. PCT/JP2022/028681 filed on Jul. 26, 2022 which claims priority from Japanese Patent Application No. 2021-122437 filed on Jul. 27, 2021. The contents of these applications are incorporated herein by reference in their entireties.

### BACKGROUND ART

### Technical Field

The present disclosure relates to a handle, a shaver, a hair dryer, a hair styling iron, a hairbrush, and an eyelash curler.

Patent Document 1 describes a shaver including a handle having a columnar casing and a razor portion connected to the casing. The shaver is used by gripping the handle with the user's hand and moving the razor portion along the user's skin.

Patent Document 1: Japanese Unexamined Patent Application Publication (Translation of PCT Application) No. 2017-536948

### BRIEF SUMMARY

When using the shaver as described in Patent Document 1, it is assumed that there is an ideal way to move the shaver to shave efficiently or to not collide with another object. However, the way of moving the shaver is entirely up to the user, and the shaver cannot guide the user to move the shaver. Note that this problem is not unique to the shaver, and a similar problem may occur with a device that the user uses by gripping the handle, such as a hair dryer, a hair styling iron, a hairbrush, and an eyelash curler.

An aspect of the present disclosure to solve the above problem is a handle including: a casing that is grippable by a user with a hand and fingers; a first vibrating body incorporated in the casing; a second vibrating body incorporated in the casing; and a control device capable of generating a first sense of force in a first direction by controlling a vibration pattern of the first vibrating body, and capable of generating a second sense of force in a second direction by controlling a vibration pattern of the second vibrating body, in which the control device is capable of controlling the vibration pattern of the first vibrating body and the vibration pattern of the second vibrating body so that the first direction and the second direction are different directions, and an imaginary line headed toward the first direction from the first vibrating body and an imaginary line headed toward the second direction from the second vibrating body are not located on the same straight line.

According to the above configuration, it is possible to give the user gripping the casing of the handle a sense of force that feels as if the handle is rotating. Accordingly, it is possible to give the user guidance on rotating the handle.

An aspect of the present disclosure to solve the above problem is a shaver including: a handle including a first vibrating body and a second vibrating body; a head coupled to the handle and including blades for cutting hair; an inclination sensor that detects an attitude of the handle; and a control device capable of generating a first sense of force in a first direction by controlling a vibration pattern of the first vibrating body, and capable of generating a second sense of force in a second direction by controlling a vibration pattern of the second vibrating body, in which the control device is capable of executing first control of controlling the vibration pattern of the first vibrating body and the vibration pattern of the second vibrating body so that the first direction and the second direction are different directions, and an imaginary line headed toward the first direction from the first vibrating body and an imaginary line headed toward the second direction from the second vibrating body are not located on the same straight line, and executes the first control on condition that the attitude of the handle is an attitude within a predetermined range.

According to the above configuration, when shaving the beard around the chin, for example, the shaver is moved while changing the attitude of the handle. In addition, when shaving the beard around the chin, the attitude of the handle is likely to be within a certain range. According to the above configuration, in a case where the attitude of the handle is an attitude within a predetermined range, it is possible to give a sense of force of rotation of the handle. Hence, it is possible to give guidance on changing the attitude of the handle, that is, of the shaver.

An aspect of the present disclosure to solve the above problem is a hair dryer including: a handle including a first vibrating body and a second vibrating body; a head coupled to the handle and capable of blowing air; and a control device capable of generating a first sense of force in a first direction by controlling a vibration pattern of the first vibrating body, and capable of generating a second sense of force in a second direction by controlling a vibration pattern of the second vibrating body, in which the control device is capable of executing first control of controlling the vibration pattern of the first vibrating body and the vibration pattern of the second vibrating body so that the first direction and the second direction are different directions, and an imaginary line headed toward the first direction from the first vibrating body and an imaginary line headed toward the second direction from the second vibrating body are not located on the same straight line, and second control of controlling the vibration pattern of the first vibrating body and the vibration pattern of the second vibrating body so that the first direction is a direction opposite to that in the first control, and the second direction is a direction opposite to that in the first control.

In the above configuration, for example, when drying the hair, the head can be shaken vertically or horizontally so that air is not blown continuously on a specific part. According to the above configuration, by executing the first control or the second control, it is possible to give a sense of force of rotation of the handle, and therefore to give guidance on changing the attitude of the handle, that is, of the hair dryer.

An aspect of the present disclosure to solve the above problem is a hair styling iron including: a handle including a first vibrating body and a second vibrating body; a head coupled to the handle and including a first nipping portion and a second nipping portion for nipping hair; an inclination sensor that detects an attitude of the handle; and a control device capable of generating a first sense of force in a first direction by controlling a vibration pattern of the first vibrating body, and capable of generating a second sense of force in a second direction by controlling a vibration pattern of the second vibrating body, in which the control device is capable of executing first control of controlling the vibration pattern of the first vibrating body and the vibration pattern of the second vibrating body so that the first direction and the second direction are different directions, and an imaginary line headed toward the first direction from the first vibrating body and an imaginary line headed toward the second direction from the second vibrating body are not located on the same straight line, and executes the first control in a case where a change in the attitude including movement of the first vibrating body in the second direction and movement of the second vibrating body in the first direction is detected by the inclination sensor.

In the above configuration, when moving the hair styling iron, if the attitude starts to change in a twisting manner the first control can give a sense of force that feels as if such change of attitude is curbed. Hence, it is possible to give guidance on not changing the attitude of the handle, that is, of the hair styling iron.

An aspect of the present disclosure to solve the above problem is a hairbrush including: a handle including a first vibrating body and a second vibrating body; a head coupled to the handle and including a brush for brushing hair; and a control device capable of generating a first sense of force in a first direction by controlling a vibration pattern of the first vibrating body, and capable of generating a second sense of force in a second direction by controlling a vibration pattern of the second vibrating body, in which the control device is capable of executing, only for a predetermined time, first control of controlling the vibration pattern of the first vibrating body and the vibration pattern of the second vibrating body so that the first direction and the second direction are different directions, and an imaginary line headed toward the first direction from the first vibrating body and an imaginary line headed toward the second direction from the second vibrating body are not located on the same straight line.

According to the above configuration, it is possible to give the hand gripping the casing of the handle a sense of rotation for a specified amount for each specified time period. Hence, the user is guided to perform a rotating operation according to a sense of rotation with repeatability. That is guidance that enables reproduction of a predetermined operation can be given.

An aspect of the present disclosure to solve the above problem is an eyelash curler including: a handle including a first vibrating body and a second vibrating body; a head coupled to the handle and having a clip configured to nip eyelashes; an inclination sensor that detects an attitude of the handle; and a control device capable of generating a first sense of force in a first direction by controlling a vibration pattern of the first vibrating body, and capable of generating a second sense of force in a second direction by controlling a vibration pattern of the second vibrating body, in which the control device is capable of executing first control of controlling the vibration pattern of the first vibrating body and the vibration pattern of the second vibrating body so that the first direction and the second direction are different directions, and an imaginary line headed toward the first direction from the first vibrating body and an imaginary line headed toward the second direction from the second vibrating body are not located on the same straight line, and executes the first control on condition that a change in the attitude of the handle is a predetermined change.

According to the above configuration, when the change in attitude of the handle is a predetermined change, it is possible to give a sense of force of prompting such an attitude change by the first control. Hence, it is possible to give guidance on continuing the change in attitude of the handle, that is, of the eyelash curler.

An aspect of the present disclosure to solve the above problem is a handle including: a casing grippable by a user with a hand and fingers; a haptics portion incorporated in the casing; and a control unit that controls the haptics portion, in which the control unit is capable of controlling the haptics portion so as to give a user gripping the casing a sense of force that feels as if the casing is rotating.

According to the above configuration, it is possible to give the user gripping the casing of the handle a sense of force that feels as if the handle is rotating. Accordingly, it is possible to give the user guidance on rotating the handle.

By giving a sense of force to the user, it is possible to give the user guidance on rotating the handle.

### BRIEF DESCRIPTION OF THE DRAWINGS

FIG. 1 is an overall view of a shaver of a first embodiment.

FIG. 2 is an explanatory view illustrating a use state of the shaver of the first embodiment.

FIG. 3 is an explanatory view illustrating a use state of the shaver of the first embodiment.

FIG. 4 is an overall view of a hair dryer of a second embodiment.

FIG. 5 is an explanatory view illustrating a use state of the hair dryer of the second embodiment.

FIG. 6 is a cross-sectional view taken along line A-A of FIG. 4.

FIG. 7 is an overall view of a hair styling iron of a third embodiment.

FIG. 8 is an explanatory view illustrating a use state of the hair styling iron of the third embodiment.

FIG. 9 is a cross-sectional view taken along line B-B of FIG. 7.

FIG. 10 is an overall view of a hairbrush of a fourth embodiment.

FIG. 11 is an explanatory view illustrating a use state of the hairbrush of the fourth embodiment.

FIG. 12 is a cross-sectional view taken along line C-C of FIG. 10.

FIG. 13 is an overall view illustrating an eyelash curler of a fifth embodiment.

FIG. 14 is an explanatory view illustrating a use state of the eyelash curler of the fifth embodiment.

FIG. 15 is a cross-sectional view taken along line D-D of FIG. 13.

### DETAILED DESCRIPTION

### First Embodiment

Hereinafter, a first embodiment in which a handle is applied to a shaver will be described with reference to the drawings. Note that components in the drawings may be enlarged to facilitate understanding in some cases. The dimensional ratio of components may differ from the actual ratio or ratios in other drawings.

### (Overall Configuration)

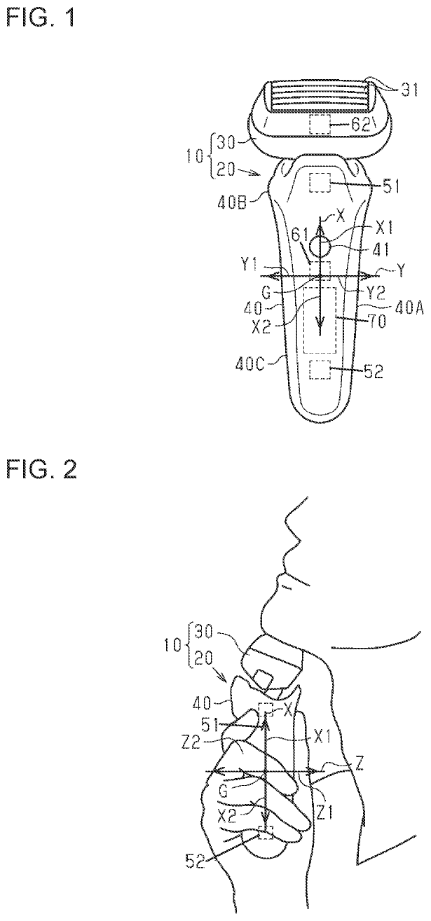

As illustrated in FIG. 1, a shaver 10 includes a handle 20 and a head 30. The handle 20 includes a casing 40 that the user can grip with the hand and fingers. The casing 40 has a cylindrical shape as a whole.

An axis passing through a center of gravity G of the casing 40 and extending in a direction in which the casing 40 extends is referred to as a first reference axis X. In addition, one of axes orthogonal to the first reference axis X is referred to as a second reference axis Y. Further, an axis orthogonal to both the first reference axis X and the second reference axis Y is referred to as a third reference axis Z. Then, one of directions along the first reference axis X is referred to as a first positive direction X1, and, of the directions along the first reference axis X, the direction opposite to the first positive direction X1 is referred to as a first negative direction X2. In addition, one of directions along the second reference axis Y is referred to as a second positive direction Y1, and, of the directions along the second reference axis Y, the direction opposite to the second positive direction Y1 is referred to as a second negative direction Y2. Further, one of directions along the third reference axis Z is referred to as a third positive direction Z1, and, of the directions along the third reference axis Z, the direction opposite to the third positive direction Z1 is referred to as a third negative direction Z2.

The size of the casing 40 in the direction along the first reference axis X is larger than the size of the casing 40 in the direction along the second reference axis Y. In addition, the size of the casing 40 in the direction along the first reference axis X is larger than the size of the casing 40 in the direction along the third reference axis Z. That is, the casing 40 has a shape long in the direction along the first reference axis X. The casing 40 is provided with a switch 41 for turning on and off the power of the shaver 10.

The casing 40 is divided broadly into a grip portion 40A, a first end portion 40B, and a second end portion 40C. The grip portion 40A is a central portion of the casing 40 including the center of gravity G. More specifically, the grip portion 40A is a part that can be located on the inside of the fingers when the user grips the casing 40 with the hand and fingers. In this embodiment, with the center of gravity G as the center, a range of a total of 10 cm which is 5 cm in the first positive direction X1 and 5 cm in the first negative direction X2 is referred to as the grip portion 40A. The first end portion 40B is adjacent to the end of the grip portion 40A on the first positive direction X1 side. The second end portion 40C is adjacent to the end of the grip portion 40A on the first negative direction X2 side.

As illustrated in FIG. 2, the head 30 is coupled to the end of the casing 40 on the first positive direction X1 side, that is, the first end portion 40B. The head 30 has a rectangular shape long in the direction along the second reference axis Y as a whole. The head 30 is inclined slightly toward the third positive direction Z1 as it extends toward the first positive direction X1. The head 30 has a plurality of blades 31. The blades 31 of the head 30 cut hair such as a beard protruding from the skin when the head 30 moves along the skin.

As illustrated in FIG. 1, the handle 20 includes a first vibrating body 51 and a second vibrating body 52. The first vibrating body 51 is incorporated in the first end portion 40B of the casing 40. The first vibrating body 51 has a substantial cube shape. Each of outer surfaces of the first vibrating body 51 faces the first positive direction X1, the first negative direction X2, the second positive direction Y1, the second negative direction Y2, the third positive direction Z1, and the third negative direction Z2.

Although not illustrated, the first vibrating body 51 includes a voice coil motor corresponding to each surface, a weight corresponding to each voice coil motor, and a cuboid case for storing these components. The weight is vibrated by a force occurring when a current flows through the coil of the voice coil motor. When the weight vibrates, the case vibrates due to the vibration of the weight. Hence, by controlling the currents flowing through the coils of the voice coil motors, the first vibrating body 51 vibrates in each of the direction along the first reference axis X, the direction along the second reference axis Y, and the direction along the third reference axis Z. To be more specific, one example is a vibrating body described in Japanese Unexamined Patent Application Publication No. 2005-190465. The first vibrating body 51 is located on the first reference axis X. In addition, the first vibrating body 51 is located on the first positive direction X1 side when viewed from the center of gravity G of the casing 40.

The second vibrating body 52 is incorporated in the second end portion 40C of the casing 40. The second vibrating body 52 is a vibrating body similar to the first vibrating body 51. The second vibrating body 52 is located on the first reference axis X. The second vibrating body 52 is located on the first negative direction X2 side when viewed from the center of gravity G of the casing 40. The distance from the center of gravity G of the casing 40 to the first vibrating body 51 is equal to the distance from the center of gravity G of the casing 40 to the second vibrating body 52.

The shaver 10 includes an inclination sensor 61 and a pressure sensor 62. The inclination sensor 61 is a three-axis acceleration sensor. That is, the inclination sensor 61 detects the attitude of the handle 20 with respect to the direction of gravity. Specifically, the inclination sensor 61 stores in advance the direction of the first negative direction X2 as viewed from the inclination sensor 61. Note that the first negative direction X2 is a fixed direction determined by the shape of the casing 40, and the first negative direction X2 as viewed from the inclination sensor 61 is also a constantly fixed direction. Next, the inclination sensor 61 identifies the direction of gravity on the basis of the detected acceleration. Then, the inclination sensor 61 identifies, as an inclination angle of the first reference axis X, an angle formed by a straight line extending in the direction of gravity from the inclination sensor 61 and a straight line extending in the first negative direction X2 from the inclination sensor 61 on a plane including both of the straight lines.

Accordingly, the inclination sensor 61 senses an inclination angle of zero degrees in a case where the direction of gravity matches the first negative direction X2. The inclination sensor 61 senses an inclination angle of 180 degrees in a case where the direction of gravity matches the first positive direction X1.

The pressure sensor 62 is located in the vicinity of the blades 31 of the head 30. The pressure sensor 62 detects pressure toward the first negative direction X2 from the blades 31. That is, the pressure sensor 62 detects that the blades 31 are pressed against the user's skin.

The shaver 10 includes a control device 70. The control device 70 includes a CPU and a ROM, and executes software processing. The control device 70 acquires a signal indicating the inclination angle of the first reference axis X from the inclination sensor 61. The control device 70 acquires a signal indicating pressure from the pressure sensor 62. Then, the control device 70 controls, in particular, the operation of the first vibrating body 51 and the operation of the second vibrating body 52.

The control device 70 can generate a sense of force in the first vibrating body 51 by controlling the vibration pattern of the first vibrating body 51. In the present embodiment, the direction of the sense of force generated from the first vibrating body 51 can be selected from any of the first positive direction X1, the first negative direction X2, the second positive direction Y1, the second negative direction Y2, the third positive direction Z1, and the third negative direction Z2. To be specific, the control device 70 generates a vibration having any of the direction along the first reference axis X, the direction along the second reference axis Y, and the direction along the third reference axis Z as the amplitude direction by controlling the current flowing through each voice coil motor of the first vibrating body 51. Further, the control device 70 controls the vibration pattern of such a vibration in a direction along one reference axis to generate a sense of force in one or the other direction of the reference axis. Note that a sense of force is a sense of resistance received from an object. Accordingly, for example, when a sense of force in the first positive direction X1 is generated in the first vibrating body 51, the user feels as if the first vibrating body 51 is displaced toward the first positive direction X1 even though the first vibrating body 51 is actually vibrating back and forth in the same position. Hereinafter, the sense of force generated by the first vibrating body 51 is referred to as a first sense of force, and the direction of the first sense of force is referred to as a first direction.

As with the first vibrating body 51, the control device 70 can generate a sense of force in the second vibrating body 52 by controlling the vibration pattern of the second vibrating body 52. Hereinafter, the sense of force generated by the second vibrating body 52 is referred to as a second sense of force, and the direction of the second sense of force is referred to as a second direction.

The control device 70 can execute first control in which the first direction of the first sense of force and the second direction of the second sense of force are set to specific directions. When the first control is executed, the first direction and the second direction become opposite directions. Moreover, when the first control is executed, an imaginary line headed in the first direction from the first vibrating body 51 and an imaginary line headed in the second direction from the second vibrating body 52 are not located on the same straight line.

The control device 70 can execute two different types of control as the first control. Of the two types of first control, one is rotation promotion control and the other is rotation curbing control. The control device 70 executes rotation promotion control or rotation curbing control depending on the attitude of the handle 20 acquired from the inclination sensor 61 and the pressure acquired from the pressure sensor 62.

The control device 70 executes rotation promotion control using the fact that the attitude of the handle 20 is an attitude within a predetermined range as one condition. An attitude within a predetermined range is such an attitude that the handle 20 generally extends along an axis along the direction of gravity. Specifically, an attitude within a predetermined range means that the inclination angle of the first reference axis X 10 degrees or smaller.

In addition, the control device 70 executes rotation promotion control using, as one condition, the fact that a state where the pressure acquired by the pressure sensor 62 is higher than a specified pressure specified in advance continues for a certain time or longer. The specified pressure is defined as a pressure that can be used to detect that the head 30 is in contact with the skin. The certain time is time long enough to determine that the user is shaving, and is defined as several seconds, for example.

When the above two conditions are satisfied, the control device 70 executes rotation promotion control. When executing the rotation promotion control, the control device 70 matches the first direction which is the direction of the first sense of force of the first vibrating body 51 with the third negative direction Z2. In addition, when executing the rotation promotion control, the control device 70 matches the second direction which is the direction of the second sense of force of the second vibrating body 52 with the third positive direction Z1. Accordingly, when the control device 70 executes rotation promotion control, the user gets a sense of force that feels as if the head 30 of the shaver 10 is displaced toward the direction of gravity.

The control device 70 executes rotation curbing control using the fact that a change in the attitude of the handle 20 is detected by the inclination sensor 61 as one condition. Here, assume that a change amount per unit time of movement of the first vibrating body 51 in the third positive direction Z1 or the third negative direction Z2 is a first movement change amount. In addition, assume that a change amount per unit time of movement of the second vibrating body 52 in a direction opposite to the direction in which the first vibrating body 51 moves is a second movement change amount. A change in the attitude of the handle 20 means that the difference between the first movement change amount and the second movement change amount per unit time becomes larger than a predetermined threshold. Note that the difference between the first movement change amount and the second movement change amount per unit time is calculated by subtraction or division. The threshold is defined, in advance by a test or the like, as a value indicating an amount of a sudden rotation of one of the first end portion 40B or the second end portion 40C of the handle 20 with respect to the other when the handle 20 is viewed from the second reference axis Y.

Specifically, the control device 70 detects that the attitude of the handle 20 has changed when the following conditions are satisfied. First, one condition is that the change in the inclination angle of the first reference axis X acquired by the inclination sensor 61 exceeds an allowable change amount per unit time. The allowable change amount per unit time is 15 degrees every 0.1 seconds, for example. In addition, the control device 70 executes rotation curbing control using, as one condition, the fact that the pressure acquired by the pressure sensor 62 changes from a specified pressure or higher to lower than the specified pressure. Thus, the control device 70 executes rotation curbing control in a case where the second end portion 40C rotates about the head 30 and the head 30 comes off of the skin, for example, when the handle 20 is viewed from the second reference axis Y.

When the above two conditions are satisfied, the control device 70 executes rotation curbing control. When executing the rotation curbing control, the control device 70 sets the first direction of the first vibrating body 51 and the second direction of the second vibrating body 52 so as to generate a sense of force of rotation in a direction opposite to the direction of the rotation of the handle 20. For example, assume that the handle 20 rotates so that the first vibrating body 51 moves in the third negative direction Z2 and the second vibrating body 52 moves in the third positive direction Z1. In this case, in rotation curbing control, the control device 70 sets the first direction of the first vibrating body 51 to the third positive direction Z1 and sets the second direction of the second vibrating body 52 to the third negative direction Z2. That is, the first movement change amount is the change amount per unit time of movement of the first vibrating body 51 in the second direction, and the second movement change amount is the change amount per unit time of movement of the second vibrating body 52 in the first direction. Meanwhile, assume that the handle 20 rotates so that the first vibrating body 51 moves in the third positive direction Z1 and the second vibrating body 52 moves in the third negative direction Z2, for example. In this case, in rotation curbing control, the control device 70 sets the first direction of the first vibrating body 51 to the third negative direction Z2 and sets the second direction of the second vibrating body 52 to the third positive direction Z1. Note that in a case of a rotation where the first vibrating body 51 moves in the second positive direction Y1 or the second negative direction Y2, too, the first direction of the first vibrating body 51 and the second direction of the second vibrating body 52 are set so as to generate a sense of force of rotation in a direction opposite to the direction of the rotation.

### (Operation of First Embodiment)

As illustrated in FIG. 2, assume that the user shaves the beard under the chin. In this case, the user holds the shaver 10 so that the third positive direction Z1 of the shaver 10 faces the rear of the user. In addition, the user presses the head 30 against the skin under the chin with such an attitude that the first reference axis X of the handle 20 generally extends along an axis along the direction of gravity. That is, the inclination angle of the handle 20 is within a range of 10 degrees or smaller, and a state where the pressure acquired by the pressure sensor 62 is higher than a specified pressure continues for a certain time or longer. Accordingly, the conditions for executing rotation promotion control of the first control are satisfied.

In rotation promotion control, the first direction of the first vibrating body 51 is set to the third negative direction Z2 and the second direction of the second vibrating body 52 is set to the third positive direction Z1. Hence, the user gets, from the handle 20, a sense of force that feels as if the head 30 is moving toward the direction of gravity while moving along the skin from under the chin toward the mouth.

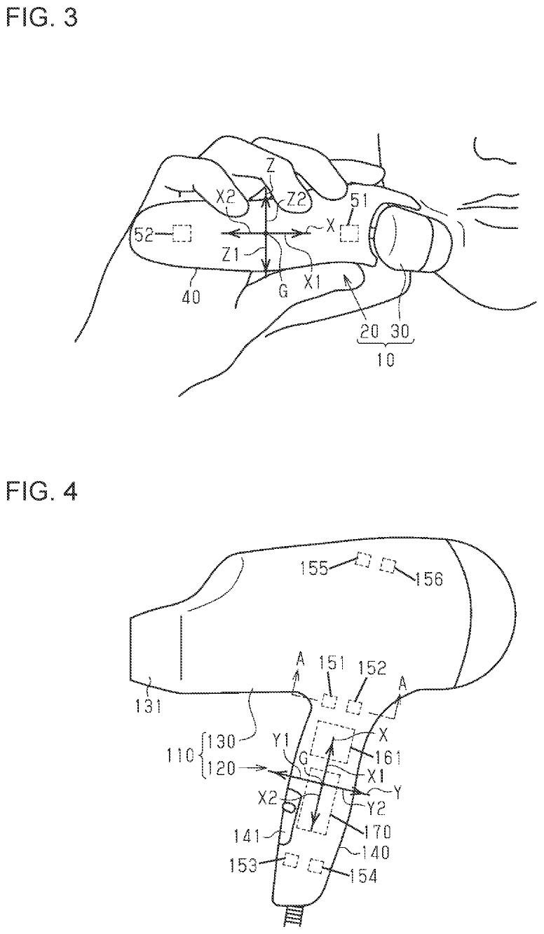

As illustrated in FIG. 3, assume that the user shaves the beard on the cheek. In this case, first, since a first inclination angle is an angle close to 90 degrees, rotation promotion control is not executed. Meanwhile, when the user operates the handle 20 along the cheek, the attitude of the shaver 10 may change suddenly due to a twist of the wrist or the like. For example, the change in the attitude of the handle 20 may be a change including a rotation about the second reference axis Y and the head 30 may come off of the skin. Alternatively, for example, the change in the attitude of the handle 20 may be a change including a rotation in which the second end portion 40C moves by rotating about the head 30 when the shaver 10 is viewed from a direction along the second reference axis Y, and the head 30 may come off of the skin. In these cases, the conditions for executing rotation curbing control of the first control are satisfied.

In rotation curbing control, the first direction of the first vibrating body 51 and the second direction of the second vibrating body 52 are set so as to generate a sense of force of rotation in a direction opposite to the direction of the actual rotation of the handle 20. Hence, when shaving the beard on the cheek, the user feels a sense of force in a direction in which the attitude of the handle 20 does not change, that is, a sense of force of a rotation in a direction opposite to the direction of the actual rotation.

### (Effect of First Embodiment)

(1-1) According to the first embodiment, in the first control, the first direction and the second direction are directions opposite to each other. Further, in the first control, the vibration pattern of the first vibrating body 51 and the vibration pattern of the second vibrating body 52 are controlled so that an imaginary line headed in the first direction from the first vibrating body 51 and an imaginary line headed in the second direction from the second vibrating body 52 are not located on the same straight line. Hence, it is possible to give a sense of force that feels as if the handle 20 is rotating to the user who is gripping the casing 40 of the handle 20. Accordingly, it is possible to give the user guidance on rotating the handle 20.

(1-2) According to the first embodiment, the first vibrating body 51 is located on the first positive direction X1 side when viewed from the center of gravity G of the casing 40. In addition, the second vibrating body 52 is located on the first negative direction X2 side when viewed from the center of gravity G of the casing 40. Hence, it is possible to give the user guidance on rotating the long casing 40 in a direction of inverting the casing 40.

(1-3) According to the first embodiment, the distance from the center of gravity G of the casing 40 to the first vibrating body 51 is equal to the distance from the center of gravity G of the casing 40 to the second vibrating body 52. Hence, by setting the magnitude of the first sense of force presented by the first vibrating body 51 equal to the magnitude of the second sense of force presented by the second vibrating body 52, it is possible to generate a sense of force of rotation of the casing 40 about the center of gravity G of the casing 40. Accordingly, there is no need to adopt the first vibrating body 51 and the second vibrating body 52 having different specifications, or to control the first vibrating body 51 and the second vibrating body 52 with different amplitude patterns.

(1-4) In the first embodiment, the casing 40 has the grip portion 40A, the first end portion 40B, and the second end portion 40C. Then, the first vibrating body 51 is incorporated in the first end portion 40B. The second vibrating body 52 is incorporated in the second end portion 40C. Hence, the first vibrating body 51 and the second vibrating body 52 are located far from each other. Hence, the first sense of force and the second sense of force are generated in parts far from the center of gravity G of the casing 40. As a result, the sense of force can be given to the user efficiently, so that it is possible to generate a sense of force of rotation for the user.

(1-5) In the above first embodiment, when shaving the beard around the chin, for example, the shaver 10 is moved while changing the attitude of the handle 20. In addition, when shaving the beard around the chin, the attitude of the handle 20 is likely to be within a certain range. According to the first embodiment, in a case where the attitude of the handle 20 is an attitude within a predetermined range, it is possible to give a sense of force of rotation of the handle 20 by rotation promotion control. Hence, it is possible to give guidance on changing the attitude of the handle 20, that is, of the shaver 10.

(1-6) According to the above first embodiment, when shaving the beard on the cheek, for example, the shaver 10 can move without changing the attitude of the handle 20 abruptly. According to the above first embodiment, it is possible to give guidance on resuming the original attitude of the shaver 10 by rotation curbing control in a case where the attitude of the handle 20 changes suddenly.

### Second Embodiment

Hereinafter, a second embodiment in which a handle is applied to a hair dryer will be described with reference to the drawings. Note that components in the drawings may be enlarged to facilitate understanding in some cases. The dimensional ratio of components may differ from the actual ratio or ratios in other drawings.

### (Overall Configuration)

As illustrated in FIG. 4, a hair dryer 110 includes a handle 120 and a head 130. The handle 120 includes a casing 140 that the user can grip with the hand and fingers. The casing 140 has a cylindrical shape as a whole.

An axis passing through a center of gravity G of the casing 140 and extending in a direction in which the casing 140 extends is referred to as a first reference axis X. In addition, one of axes orthogonal to the first reference axis X is referred to as a second reference axis Y. Further, an axis orthogonal to both the first reference axis X and the second reference axis Y is referred to as a third reference axis Z. Then, one of directions along the first reference axis X is referred to as a first positive direction X1, and, of the directions along the first reference axis X, the direction opposite to the first positive direction X1 is referred to as a first negative direction X2. In addition, one of directions along the second reference axis Y is referred to as a second positive direction Y1, and, of the directions along the second reference axis Y, the direction opposite to the second positive direction Y1 is referred to as a second negative direction Y2. Further, one of directions along the third reference axis Z is referred to as a third positive direction Z1, and, of the directions along the third reference axis Z, the direction opposite to the third positive direction Z1 is referred to as a third negative direction Z2.

The size of the casing 140 in the direction along the first reference axis X is larger than the size of the casing 140 in the direction along the second reference axis Y. In addition, the size of the casing 140 in the direction along the first reference axis X is larger than the size of the casing 140 in the direction along the third reference axis Z. That is, the casing 140 has a shape long in the direction along the first reference axis X. The casing 140 is provided with a switch 141 for turning on and off the power of the hair dryer 110.

The head 130 is coupled to the end of the casing 140 on the first positive direction X1 side. The head 130 has a tubular shape long in the direction along the second reference axis Y as a whole. The head 130 has a blower portion 131 that can blow warm air. Although not illustrated, the blower portion 131 has a heating element for heating air and a fan for blowing air. Heated air is blown outward from the tip end side of the blower portion 131 of the head 130. By blowing the warm air from the head 130 on the hair, it is possible to dry the hair at the blowing end. Note that the blower portion 131 only needs to be able to blow air, and may be able to blow cold air in addition to warm air.

The hair dryer 110 includes a first vibrating body 151, a second vibrating body 152, a third vibrating body 153, a fourth vibrating body 154, a fifth vibrating body 155, and a sixth vibrating body 156. Each vibrating body has a similar configuration to the vibrating body of the first embodiment.

The first vibrating body 151 is incorporated in the casing 140 of the handle 120. The first vibrating body 151 is located on the first positive direction X1 side and on the second positive direction Y1 side when viewed from the center of gravity G of the casing 140.

The second vibrating body 152 is incorporated in the casing 140 of the handle 120. The second vibrating body 152 is located on the first positive direction X1 side and on the second negative direction Y2 side when viewed from the center of gravity G of the casing 140. The distance from the center of gravity G of the casing 140 to the first vibrating body 151 is equal to the distance from the center of gravity G of the casing 140 to the second vibrating body 152.

The third vibrating body 153 is incorporated in the casing 140 of the handle 120. The third vibrating body 153 is located on the first negative direction X2 side and on the second positive direction Y1 side when viewed from the center of gravity G of the casing 140. The distance from the center of gravity G of the casing 140 to the third vibrating body 153 is equal to the distance from the center of gravity G of the casing 140 to the first vibrating body 151.

The fourth vibrating body 154 is incorporated in the casing 140 of the handle 120. The fourth vibrating body 154 is located on the first negative direction X2 side and on the second negative direction Y2 side when viewed from the center of gravity G of the casing 140. The distance from the center of gravity G of the casing 140 to the second vibrating body 152 is equal to the distance from the center of gravity G of the casing 140 to the fourth vibrating body 154.

The fifth vibrating body 155 is incorporated in the head 130. The fifth vibrating body 155 is located on the first positive direction X1 side and on the second positive direction Y1 side when viewed from the center of gravity G of the casing 140. The sixth vibrating body 156 is incorporated in the head 130. The sixth vibrating body 156 is located on the first positive direction X1 side and on the second negative direction Y2 side when viewed from the center of gravity G of the casing 140. The distance from the center of gravity G of the casing 140 to the fifth vibrating body 155 is equal to the distance from the center of gravity G of the casing 140 to the sixth vibrating body 156.

The first vibrating body 151, the third vibrating body 153, and the fifth vibrating body 155 are provided in the same position when the hair dryer 110 is viewed in the direction along the first reference axis X. The second vibrating body 152, the fourth vibrating body 154, and the sixth vibrating body 156 are provided in the same position when the hair dryer 110 is viewed in the direction along the first reference axis X. Moreover, when the hair dryer 110 is viewed in the direction along the first reference axis X, the position of the first vibrating body 151 and the position of the second vibrating body 152 are symmetrical with respect to the first reference axis X.

The hair dryer 110 includes an inclination sensor 161. The inclination sensor 161 has a similar configuration to the inclination sensor 61 of the first embodiment. That is, the inclination sensor 161 detects the inclination angle of the first reference axis X with respect to the direction of gravity.

The hair dryer 110 includes a control device 170. The control device 170 includes a CPU and a ROM, and executes software processing. The control device 170 acquires a signal indicating an inclination from the inclination sensor 161. Then, the control device 170 controls the operation of each vibrating body.

The control device 170 can generate a first sense of force in a first direction from the first vibrating body 151 by controlling the vibration pattern of the first vibrating body 151. The control device 170 can generate a second sense of force in a second direction from the second vibrating body 152 by controlling the vibration pattern of the second vibrating body 152. The control device 170 can generate a third sense of force in a third direction from the third vibrating body 153 by controlling the vibration pattern of the third vibrating body 153. The control device 170 can generate a fourth sense of force in a fourth direction from the fourth vibrating body 154 by controlling the vibration pattern of the fourth vibrating body 154. The control device 170 can generate a fifth sense of force in a fifth direction from the fifth vibrating body 155 by controlling the vibration pattern of the fifth vibrating body 155. The control device 170 can generate a sixth sense of force in a sixth direction from the sixth vibrating body 156 by controlling the vibration pattern of the sixth vibrating body 156.

The control device 170 can execute first control and second control of controlling the vibration pattern of the vibrating bodies. When the first control is executed, the first direction and the second direction become opposite directions. Moreover, when the first control is executed, an imaginary line headed in the first direction from the first vibrating body 151 and an imaginary line headed in the second direction from the second vibrating body 152 are not located on the same straight line. In the second embodiment, when the first control is executed, the relationship between the third direction and the fourth direction, too, becomes similar to the relationship between the first direction and the second direction. Moreover, when the first control is executed, the relationship between the fifth direction and the sixth direction, too, becomes similar to the relationship between the first direction and the second direction.

Specifically, when executing the first control, the control device 170 sets all of the first direction of the first sense of force, the third direction of the third sense of force, and the fifth direction of the fifth sense of force to the third positive direction Z1. In addition, when executing the first control, the control device 170 sets all of the second direction of the second sense of force, the fourth direction of the fourth sense of force, and the sixth direction of the sixth sense of force to the third negative direction Z2.

In the second control, the control device 170 sets each of the first direction to the sixth direction to a direction opposite to that in the first control. Specifically, the control device 170 sets the first direction of the first sense of force, the third direction of the third sense of force, and the fifth direction of the fifth sense of force to the third negative direction Z2. In addition, the control device 170 sets the second direction of the second sense of force, the fourth direction of the fourth sense of force, and the sixth direction of the sixth sense of force to the third positive direction Z1. That is, the second control sets opposite directions for the first direction and the second direction. Note that as with the first control, in the second control, too, an imaginary line headed in the first direction from the first vibrating body 151 and an imaginary line headed in the second direction from the second vibrating body 152 are not located on the same straight line. The same goes for the directional relationship between the third direction and the fourth direction and the directional relationship between the fifth direction and the sixth direction.

In the present embodiment, the control device 170 executes the first control and the second control alternately for predetermined periods as alternate rotation promotion control. Here, the predetermined period is less than a second, for example.

The control device 170 executes the alternate rotation promotion control on condition that the attitude of the handle 120 is an attitude within a predetermined range. Specifically, the control device 170 executes the alternate rotation promotion control on condition that the inclination angle of the first reference axis X acquired by the inclination sensor 161 becomes equal to or larger than a specified inclination angle specified in advance. The specified inclination angle is 45 degrees, for example, and is an inclination at which the attitude of the handle 120 is inclined substantially with respect to an axis along the direction of gravity.

### (Operation of Second Embodiment)

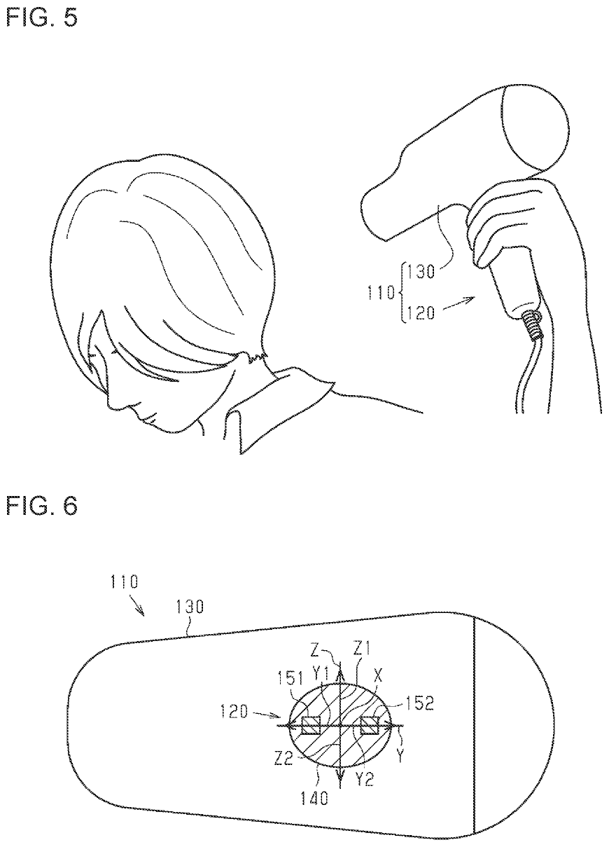

As illustrated in FIG. 5, assume that the user dries the hair around the top of the head. In this case, the user tilts the handle 120 substantially with respect to the axis along the direction of gravity to blow warm air more easily on the hair. At this time, when the first reference axis X of the handle 120 is tilted 45 degrees or larger with respect to the axis along the direction of gravity, the control device 170 alternately executes the first control and the second control in a repeated manner as alternate rotation promotion control.

As illustrated in FIG. 6, when the hair dryer 110 is viewed in the first positive direction X1, the first control gives a sense of force of a clockwise rotation about the first reference axis X to the user's hand and fingers. In addition, when the hair dryer 110 is viewed in the first positive direction X1, the second control gives a sense of force of a counterclockwise rotation about the first reference axis X to the user's hand and fingers.

Then, by repeatedly executing the first control and the second control alternately, the control device 170 can alternately give a sense of force of a clockwise rotation and a sense of force of a counterclockwise rotation about the first reference axis X to the user's hand and fingers. That is, when the control device 170 executes the alternate rotation promotion control, the user gets a sense of force that feels as if the head 130 of the hair dryer 110 is shook repeatedly.

### (Effect of Second Embodiment)

According to the second embodiment, the following effects are obtained in addition to the effects (1-1) and (1-3) of the first embodiment.

(2-1) According to the second embodiment, in a case where the user dries the hair around the top of the head, a sense of force of a clockwise rotation and a sense of force of a counterclockwise rotation about the first reference axis X are given alternately to the user's hand and fingers. As a result, it is possible to give the user guidance on performing an alternately rotating operation along with the sense of rotating the hair dryer 110 alternately.

(2-2) According to the second embodiment, the casing 140 is formed to be long in the direction along the first reference axis X. Moreover, the first vibrating body 151 is located on the second positive direction Y1 side when viewed from the center of gravity G of the casing 140. In addition, the second vibrating body 152 is located on the second negative direction Y2 side when viewed from the center of gravity G of the casing 140. Hence, according to the alternate rotation promotion control, it is possible to give the user guidance on rotating the long casing 140 alternately in twisting directions.

### Third Embodiment

Hereinafter, a third embodiment in which a handle is applied to a hair styling iron will be described with reference to the drawings. Note that components in the drawings may be enlarged to facilitate understanding in some cases. The dimensional ratio of components may differ from the actual ratio or ratios in other drawings.

### (Overall Configuration)

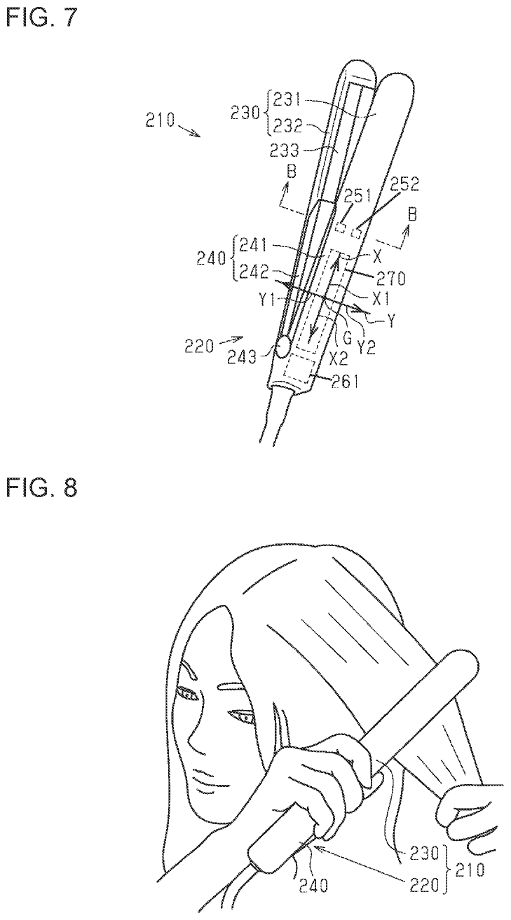

As illustrated in FIG. 7, a hair styling iron 210 includes a handle 220 and a head 230. The handle 220 includes a casing 240 that the user can grip with the hand and fingers. The casing 240 has a first casing 241 and a second casing 242. The first casing 241 is columnar as a whole. The second casing 242 is columnar as a whole.

An axis passing through a center of gravity G of the first casing 241 and extending in a direction in which the first casing 241 extends is referred to as a first reference axis X. In addition, one of axes orthogonal to the first reference axis X is referred to as a second reference axis Y. Further, an axis orthogonal to both the first reference axis X and the second reference axis Y is referred to as a third reference axis Z. Then, one of directions along the first reference axis X is referred to as a first positive direction X1, and, of the directions along the first reference axis X, the direction opposite to the first positive direction X1 is referred to as a first negative direction X2. In addition, one of directions along the second reference axis Y is referred to as a second positive direction Y1, and, of the directions along the second reference axis Y, the direction opposite to the second positive direction Y1 is referred to as a second negative direction Y2. Further, one of directions along the third reference axis Z is referred to as a third positive direction Z1, and, of the directions along the third reference axis Z, the direction opposite to the third positive direction Z1 is referred to as a third negative direction Z2.

The size of the first casing 241 in the direction along the first reference axis X is larger than the size of the first casing 241 in the direction along the second reference axis Y. In addition, the size of the first casing 241 in the direction along the first reference axis X is larger than the size of the first casing 241 in the direction along the third reference axis Z. That is, the first casing 241 has a shape long in the direction along the first reference axis X. The second casing 242, too, has a shape long in the direction along the first reference axis X.

When viewed from the first casing 241, the second casing 242 is adjacent to and substantially parallel to the first casing 241 on the third negative direction Z2 side. A first negative direction X2 end of the first casing 241 is connected to a first negative direction X2 end of the second casing 242 via a shaft body 243. The first casing 241 can rotate relative to the second casing 242 with the shaft body 243 as the rotation axis. That is, the first casing 241 and the second casing 242 are openable and closable with the shaft body 243 as a pivot.

The head 230 has a first nipping portion 231 and a second nipping portion 232. The first nipping portion 231 is coupled to the end of the first casing 241 on the first positive direction X1 side. The first nipping portion 231 has a rectangular shape long in the direction along the first reference axis X as a whole.

The second nipping portion 232 has a similar shape to the first nipping portion 231. The second nipping portion 232 has a heater 233. The second nipping portion 232 is coupled to the second casing 242 so as to face the first nipping portion 231. When the first casing 241 and the second casing 242 are closed, it is possible to nip hair between the first nipping portion 231 and the second nipping portion 232. Then, with the hair nipped between the first nipping portion 231 and the second nipping portion 232, it is possible to adjust the entire form of the hair with the heater 233 in the second nipping portion 232.

The handle 220 includes a first vibrating body 251 and a second vibrating body 252. Each vibrating body has a similar configuration to the vibrating body of the first embodiment. The first vibrating body 251 is incorporated in the first casing 241.

The first vibrating body 251 is located on the first positive direction X1 side and on the second positive direction Y1 side when viewed from the center of gravity G of the first casing 241.

The second vibrating body 252 is incorporated in the first casing 241. The second vibrating body 252 is located on the first positive direction X1 side and on the second negative direction Y2 side when viewed from the center of gravity G of the first casing 241.

The distance from the center of gravity G of the first casing 241 to the first vibrating body 251 is equal to the distance from the center of gravity G of the first casing 241 to the second vibrating body 252.

The hair styling iron 210 includes an inclination sensor 261. The inclination sensor 261 has a similar configuration to the inclination sensor 61 of the first embodiment. In the third embodiment, the inclination sensor 261 detects rotation of the first casing 241 about the first reference axis X as a change in the attitude of the first casing 241. Specifically, the inclination sensor 261 detects a rotation of the first casing 241 about the first reference axis X when both the second positive direction Y1 and the third positive direction Z1 change.

The hair styling iron 210 includes a control device 270. The control device 270 includes a CPU and a ROM, and executes software processing. The control device 270 acquires a signal indicating whether the first casing 241 has rotated. Then, the control device 270 controls the operation of each vibrating body.

The control device 270 can generate a first sense of force in a first direction from the first vibrating body 251 by controlling the vibration pattern of the first vibrating body 251. The control device 270 can generate a second sense of force in a second direction from the second vibrating body 252 by controlling the vibration pattern of the second vibrating body 252.

The control device 270 can execute first control of controlling the vibration pattern of the first vibrating body 251 and the vibration pattern of the second vibrating body 252. When the first control is executed, the first direction and the second direction become opposite directions. Moreover, when the first control is executed, an imaginary line headed in the first direction from the first vibrating body 251 and an imaginary line headed in the second direction from the second vibrating body 252 are not located on the same straight line.

In the present embodiment, the control device 270 executes first control as rotation curbing control. The control device 270 executes the rotation curbing control on condition that a change in the attitude of the handle 220 is detected by the inclination sensor 261. The control device 270 detects that there has been a change in the attitude of the handle 220 when both a change amount per unit time of the direction of the second positive direction Y1 and a change amount per unit time of the direction of the third positive direction Z1 detected by the inclination sensor 261 exceed an allowable range. The allowable change amount per unit time is 15 degrees every 0.1 seconds, for example. That is, the rotation curbing control is executed when the change in the attitude of the handle 220 is a change including rotation about the first reference axis X. Then, in the rotation curbing control, the first direction of the first vibrating body 251 and the second direction of the second vibrating body 252 are set so as to generate a sense of force of rotation of the handle 220 in a direction opposite to the direction of the rotation about the first reference axis X. That is, assume that the handle 220 rotates such that the first vibrating body 251 moves in the third negative direction Z2 and the second vibrating body 252 moves in the third positive direction Z1. In this case, the control device 270 executes the first control by setting the first direction of the first vibrating body 251 to the third positive direction Z1 and the second direction of the second vibrating body 252 to the third negative direction Z2.

### (Operation of Third Embodiment)

As illustrated in FIG. 8, assume that the user uses the hair styling iron 210 to straighten the hair. In this case, the user can move the handle 220 in parallel in the second positive direction Y1 or the second negative direction Y2 while maintaining a constant inclination angle of the first reference axis X. However, the handle 220 may rotate about the first reference axis X due to a twist of the user's wrist or the like. According to the third embodiment, when such a rotation of the handle 220 occurs, the execution condition of the first control as the rotation curbing control is satisfied.

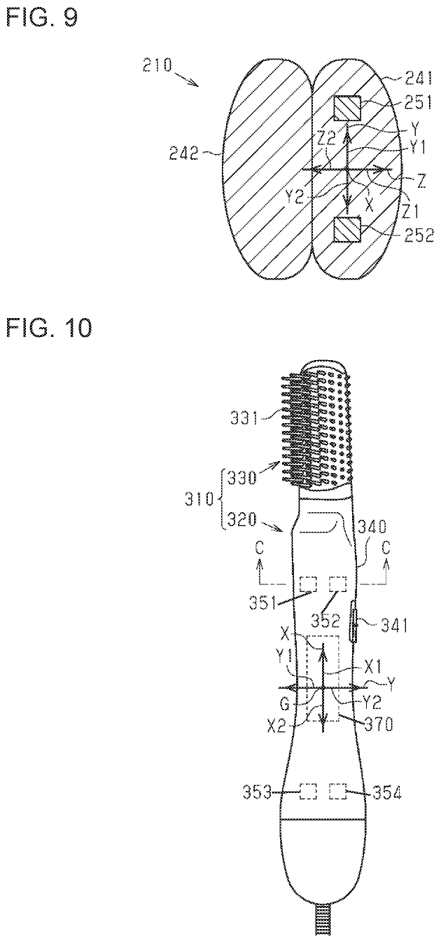

As illustrated in FIG. 9, when the hair styling iron 210 is viewed in the first positive direction X1, a sense of force of a rotation about the first reference axis X is given to the user's hand and fingers by the first control. Further, the rotation direction is opposite to the direction of the rotation caused by the twist of the wrist or the like. Note that FIG. 9 illustrates a state where the first casing 241 and the second casing 242 are closed.

### (Effect of Third Embodiment)

According to the third embodiment, the following effects are obtained in addition to effects similar to (1-1) and (1-3) of the first embodiment and (2-2) of the second embodiment.

(3-1) According to the third embodiment, when the user straightens the hair, the hair styling iron 210 can be moved without changing the attitude of the handle 220 abruptly. In this case, in a case where the attitude of the handle 220 changes suddenly, it is possible to give guidance on resuming the attitude of the hair styling iron 210 by the rotation curbing control.

### Fourth Embodiment

Hereinafter, a fourth embodiment in which a handle is applied to a hairbrush will be described with reference to the drawings. Note that components in the drawings may be enlarged to facilitate understanding in some cases. The dimensional ratio of components may differ from the actual ratio or ratios in other drawings.

### (Overall Configuration)

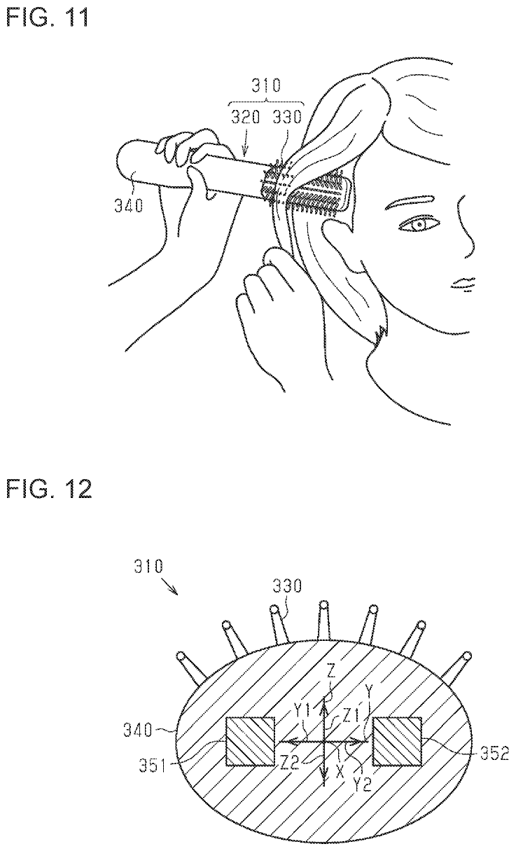

As illustrated in FIG. 10, a hairbrush 310 includes a handle 320 and a head 330. The handle 320 includes a casing 340 that the user can grip with the hand and fingers. The casing 340 has a cylindrical shape as a whole.

An axis passing through a center of gravity G of the casing 340 and extending in a direction in which the casing 340 extends is referred to as a first reference axis X. In addition, one of axes orthogonal to the first reference axis X is referred to as a second reference axis Y. Further, an axis orthogonal to both the first reference axis X and the second reference axis Y is referred to as a third reference axis Z. Then, one of directions along the first reference axis X is referred to as a first positive direction X1, and, of the directions along the first reference axis X, the direction opposite to the first positive direction X1 is referred to as a first negative direction X2. In addition, one of directions along the second reference axis Y is referred to as a second positive direction Y1, and, of the directions along the second reference axis Y, the direction opposite to the second positive direction Y1 is referred to as a second negative direction Y2. Further, one of directions along the third reference axis Z is referred to as a third positive direction Z1, and, of the directions along the third reference axis Z, the direction opposite to the third positive direction Z1 is referred to as a third negative direction Z2.

The size of the casing 340 in the direction along the first reference axis X is larger than the size of the casing 340 in the direction along the second reference axis Y. In addition, the size of the casing 340 in the direction along the first reference axis X is larger than the size of the casing 340 in the direction along the third reference axis Z. That is, the casing 340 has a shape long in the direction along the first reference axis X. The casing 340 is provided with a switch 341 for turning on and off the power of the hairbrush 310.

The head 330 is coupled to the end of the casing 340 on the first positive direction X1 side. The head 330 has a cylindrical shape long in the direction along the first reference axis X as a whole. The head 330 has a brush 331 for brushing the hair. The hair is brushed by moving the hairbrush 310 with the brush 331 pressed against the hair. Although not illustrated, the head 330 has a heating element for heating air and a fan for blowing air. The heated air is blown outward from between protrusions of the brush 331.

The hairbrush 310 includes a first vibrating body 351, a second vibrating body 352, a third vibrating body 353, and a fourth vibrating body 354. Each vibrating body has a similar configuration to the vibrating body of the first embodiment.

The first vibrating body 351 is incorporated in the casing 340 of the handle 320. The first vibrating body 351 is located on the first positive direction X1 side and on the second positive direction Y1 side when viewed from the center of gravity G of the casing 340.

The second vibrating body 352 is incorporated in the casing 340 of the handle 320. The second vibrating body 352 is located on the first positive direction X1 side and on the second negative direction Y2 side when viewed from the center of gravity G of the casing 340. The distance from the center of gravity G of the casing 340 to the first vibrating body 351 is equal to the distance from the center of gravity G of the casing 340 to the second vibrating body 352.

The third vibrating body 353 is incorporated in the casing 340 of the handle 320. The third vibrating body 353 is located on the first negative direction X2 side and on the second positive direction Y1 side when viewed from the center of gravity G of the casing 340. The distance from the center of gravity G of the casing 340 to the third vibrating body 353 is equal to the distance from the center of gravity G of the casing 340 to the first vibrating body 351.

The fourth vibrating body 354 is incorporated in the casing 340 of the handle 320. The fourth vibrating body 354 is located on the first negative direction X2 side and on the second negative direction Y2 side when viewed from the center of gravity G of the casing 340. The distance from the center of gravity G of the casing 340 to the second vibrating body 352 is equal to the distance from the center of gravity G of the casing 340 to the fourth vibrating body 354.

The first vibrating body 351 and the third vibrating body 353 are provided in the same position when the hairbrush 310 is viewed in the direction along the first reference axis X. The second vibrating body 352 and the fourth vibrating body 354 are provided in the same position when the hairbrush 310 is viewed in the direction along the first reference axis X. Moreover, when the hairbrush 310 is viewed in the direction along the first reference axis X, the position of the first vibrating body 351 and the position of the second vibrating body 352 are symmetrical with respect to the first reference axis X.

The hairbrush 310 includes a control device 370. The control device 370 includes a CPU and a ROM, and executes software processing. Then, the control device 370 controls the operation of each vibrating body.

The control device 370 can generate a first sense of force in a first direction from the first vibrating body 351 by controlling the vibration pattern of the first vibrating body 351. The control device 370 can generate a second sense of force in a second direction from the second vibrating body 352 by controlling the vibration pattern of the second vibrating body 352. The control device 370 can generate a third sense of force in a third direction from the third vibrating body 353 by controlling the vibration pattern of the third vibrating body 353. The control device 370 can generate a fourth sense of force in a fourth direction from the fourth vibrating body 354 by controlling the vibration pattern of the fourth vibrating body 354.

The control device 370 can execute first control and second control of controlling the vibration pattern of the vibrating bodies. When the first control is executed, the first direction and the second direction become opposite directions. Moreover, when the first control is executed, an imaginary line headed in the first direction from the first vibrating body 351 and an imaginary line headed in the second direction from the second vibrating body 352 are not located on the same straight line. In the fourth embodiment, when the first control is executed, the relationship between the third direction and the fourth direction, too, becomes similar to the relationship between the first direction and the second direction.

Specifically, when executing the first control, the control device 370 sets both the first direction of the first sense of force and the third direction of the third sense of force to the third positive direction Z1. In addition, when executing the first control, the control device 370 both the second direction of the second sense of force and the fourth direction of the fourth sense of force to the third negative direction Z2.

In the second control, the control device 370 sets each of the first direction to the fourth direction to a direction opposite to that in the first control. Specifically, the control device 370 sets the first direction of the first sense of force and the third direction of the third sense of force to the third negative direction Z2. In addition, the control device 370 sets the second direction of the second sense of force and the fourth direction of the fourth sense of force to the third positive direction Z1. That is, the second control sets opposite directions for the first direction and the second direction. Note that as with the first control, in the second control, too, an imaginary line headed in the first direction from the first vibrating body 351 and an imaginary line headed in the second direction from the second vibrating body 352 are not located on the same straight line. The same goes for the directional relationship between the third direction and the fourth direction.

In the present embodiment, the control device 370 executes each of the first control and the second control for fixed time periods in a predetermined order as specific rotation promotion control. For example, in the specific rotation promotion control, the order of the controls is determined so that the first control and the second control are executed alternately. In addition, in the specific rotation promotion control, the time period for executing each control is determined so that the first control is executed for three seconds and the second control is executed for one second. Then, when the user operates the switch 341 to turn on the power of the hairbrush 310, the control device 370 executes the specific rotation promotion control.

### (Operation of Fourth Embodiment)

As illustrated in FIG. 11, assume that the user uses the hairbrush 310 to curl the hair in a desired manner. In this case, the user can operate and rotate the handle 320 in a predetermined order to obtain the desired curl. However, if the specific rotation promotion control is not executed, it is difficult for the user to perform brushing with high repeatability. According to the fourth embodiment, as the specific rotation promotion control, the control device 370 executes each of the first control and the second control for predetermined time periods in a predetermined order.

As illustrated in FIG. 12, when the hairbrush 310 is viewed in the first positive direction X1, the first control gives a sense of force of a clockwise rotation about the first reference axis X to the user's hand and fingers. In addition, when the hairbrush 310 is viewed in the first positive direction X1, the second control gives a sense of force of a counterclockwise rotation about the first reference axis X to the user's hand and fingers.

### (Effect of Fourth Embodiment)

According to the fourth embodiment, the following effects are obtained in addition to effects similar to (1-1) and (1-3) of the first embodiment and (2-2) of the second embodiment.

(4-1) According to the fourth embodiment, when the specific rotation promotion control is executed, it is possible to give the fingers and hand gripping the casing 340 of the handle 320 a sense of rotation for only a specified amount for each specified time period. Hence, the user is guided to rotate the handle 320 according to a sense of rotation with repeatability. As a result, the user can perform similar brushing with high repeatability.

(4-2) According to the fourth embodiment, in the specific rotation promotion control, the first control and the second control are executed for their fixed time periods in a predetermined order. Hence, it is possible to give guidance on rotating backward by the second control for the same amount of rotation performed in the operation of the first control.

### Fifth Embodiment

Hereinafter, a fifth embodiment in which a handle is applied to an eyelash curler will be described with reference to the drawings. Note that components in the drawings may be enlarged to facilitate understanding in some cases. The dimensional ratio of components may differ from the actual ratio or ratios in other drawings.

### (Overall Configuration)

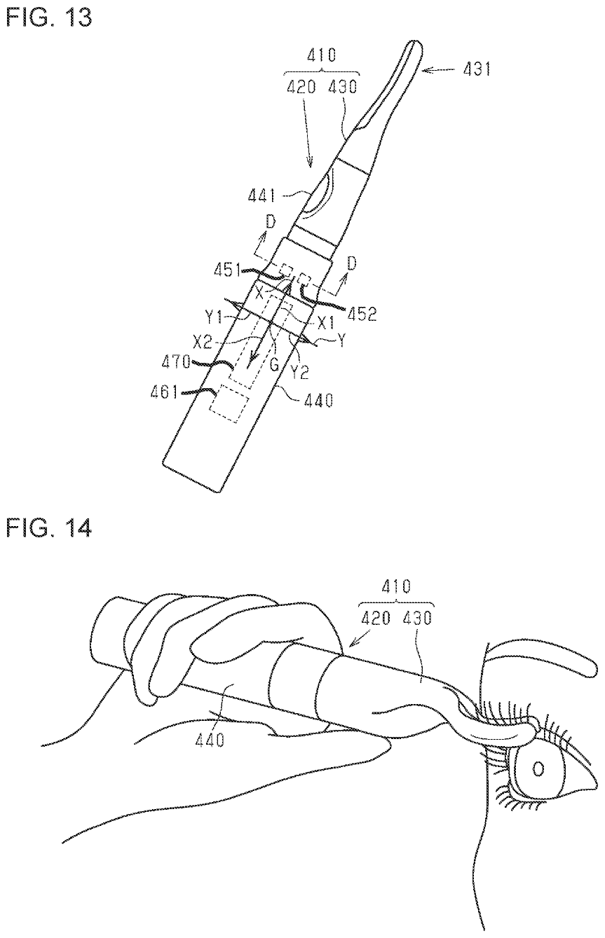

As illustrated in FIG. 13, an eyelash curler 410 includes a handle 420 and a head 430. The handle 420 includes a casing 440 that the user can grip with the hand and fingers. The casing 440 is columnar as a whole.

An axis passing through a center of gravity G of the casing 440 and extending in a direction in which the casing 440 extends is referred to as a first reference axis X. In addition, one of axes orthogonal to the first reference axis X is referred to as a second reference axis Y. Further, an axis orthogonal to both the first reference axis X and the second reference axis Y is referred to as a third reference axis Z. Then, one of directions along the first reference axis X is referred to as a first positive direction X1, and, of the directions along the first reference axis X, the direction opposite to the first positive direction X1 is referred to as a first negative direction X2. In addition, one of directions along the second reference axis Y is referred to as a second positive direction Y1, and, of the directions along the second reference axis Y, the direction opposite to the second positive direction Y1 is referred to as a second negative direction Y2. Further, one of directions along the third reference axis Z is referred to as a third positive direction Z1, and, of the directions along the third reference axis Z, the direction opposite to the third positive direction Z1 is referred to as a third negative direction Z2.

The size of the casing 440 in the direction along the first reference axis X is larger than the size of the casing 440 in the direction along the second reference axis Y. In addition, the size of the casing 440 in the direction along the first reference axis X is larger than the size of the casing 440 in the direction along the third reference axis Z. That is, the casing 440 has a shape long in the direction along the first reference axis X. The casing 440 is provided with a switch 441 for turning on and off the power of the eyelash curler 410.

The head 430 is coupled to the end of the casing 440 on the first positive direction X1 side. The head 430 has a cylindrical shape long in the direction along the first reference axis X as a whole. The head 430 has a clip 431 for nipping the eyelashes. The eyelashes are curled by nipping the eyelashes with the clip 431 of the head 430 and rotating the handle 420 about the first reference axis X. Although not illustrated, the clip 431 has a heater. When the heater is driven, the eyelashes nipped by the clip 431 are heated.

The handle 420 includes a first vibrating body 451 and a second vibrating body 452. Each vibrating body has a similar configuration to the vibrating body of the first embodiment.

The first vibrating body 451 is incorporated in the casing 440. The first vibrating body 451 is located on the first positive direction X1 side and on the second positive direction Y1 side when viewed from the center of gravity G of the casing 440.

The second vibrating body 452 is incorporated in the casing 440. The second vibrating body 452 is located on the first positive direction X1 side and on the second negative direction Y2 side when viewed from the center of gravity G of the casing 440.

The distance from the center of gravity G of the casing 440 to the first vibrating body 451 is equal to the distance from the center of gravity G of the casing 440 to the second vibrating body 452.

The eyelash curler 410 includes an inclination sensor 461. The inclination sensor 461 has a similar configuration to the inclination sensor 61 of the first embodiment. In the fifth embodiment, the inclination sensor 461 detects rotation of the casing 440 about the first reference axis X as a change in the attitude of the casing 440. Specifically, the inclination sensor 461 detects that the casing 440 has rotated about the first reference axis X when both the second positive direction Y1 and the third positive direction Z1 change.

The eyelash curler 410 includes a control device 470. The control device 470 includes a CPU and a ROM, and executes software processing. The control device 470 acquires a signal indicating whether the casing 440 has rotated from the inclination sensor 461. Then, the control device 470 controls the operation of each vibrating body.

The control device 470 can generate a first sense of force in a first direction from the first vibrating body 451 by controlling the vibration pattern of the first vibrating body 451. The control device 470 can generate a second sense of force in a second direction from the second vibrating body 452 by controlling the vibration pattern of the second vibrating body 452.

The control device 470 can execute first control of controlling the vibration pattern of the first vibrating body 451 and the vibration pattern of the second vibrating body 452. When the first control is executed, the first direction and the second direction become opposite directions. Moreover, when the first control is executed, an imaginary line headed in the first direction from the first vibrating body 451 and an imaginary line headed in the second direction from the second vibrating body 452 are not located on the same straight line.

In the present embodiment, the control device 470 executes first control as rotation promotion control. The control device 470 executes the rotation curbing control on condition that a change in the attitude of the handle 420 is detected by the inclination sensor 461. The control device 470 detects that there has been a change in the attitude of the handle 420 when both a change amount per unit time of the direction of the second positive direction Y1 and a change amount per unit time of the direction of the third positive direction Z1 detected by the inclination sensor 461 exceed an allowable range. The allowable change amount per unit time is 15 degrees every 0.1 seconds, for example. That is, the rotation promotion control is executed when the change in the attitude of the handle 420 is a change including rotation about the first reference axis X. Then, in the rotation promotion control, the first direction of the first vibrating body 451 and the second direction of the second vibrating body 452 are set so as to generate a sense of force of rotation of the handle 420 in the same direction as the rotation about the first reference axis X. That is, assume that the handle 420 rotates such that the first vibrating body 451 moves in the third negative direction Z2 and the second vibrating body 452 moves in the third positive direction Z1. In this case, the control device 470 executes the first control by setting the first direction of the first vibrating body 451 to the third negative direction Z2 and the second direction of the second vibrating body 452 to the third positive direction Z1.

### (Operation of Fifth Embodiment)

As illustrated in FIG. 14, assume that the user is using the eyelash curler 410 to curl the eyelashes. In this case, the user can continue the same operation for a predetermined time so as to rotate the handle 420 about the first reference axis X. According to the fifth embodiment, the control device 470 executes the first control by the rotation promotion control in a case where such rotation of the handle 420 occurs.

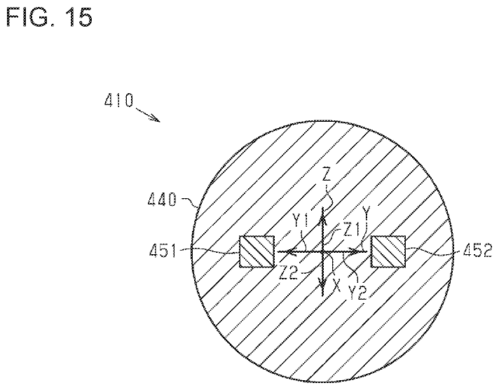

As illustrated in FIG. 15, when the eyelash curler 410 is viewed in the first positive direction X1, the first control gives a sense of force of a rotation about the first reference axis X to the user's hand and fingers. Further, the rotation direction is the same as the direction of the rotation caused by the twist of the wrist or the like.

### (Effect of Fifth Embodiment)

According to the fifth embodiment, the following effects are obtained in addition to effects similar to (1-1) and (1-3) of the first embodiment and (2-2) of the second embodiment.

(5-1) When the user curls the eyelashes, the eyelash curler 410 can be moved without changing the rotation direction of the eyelash curler 410. According to the fifth embodiment, when the first control is executed by the rotation promotion control, it is possible to give guidance on rotating the handle 420 in the same direction as the direction in which the user rotates the handle 420.

(5-2) In the fifth embodiment, the first control is executed on condition that the user rotates the eyelash curler 410 and there is a change in the attitude of the handle 420. What is more, the first control generates a sense of force in the same direction as the direction in which the user rotates the eyelash curler 410. Hence, it is possible to prevent guidance in a direction opposite to that intended by the user.

### Other Embodiments

The above embodiments can be implemented with the following modifications. The above embodiments and the following modifications can be combined within a technically consistent range.
In the embodiments, the shape of the casing can be changed appropriately. For example, in the first embodiment, the shape of the casing 40 may be a cube or a sphere. That is, the size of the casing 40 in the direction along the first reference axis X may be the same as the size of the casing 40 in the direction along the second reference axis Y, or may be smaller than the size of the casing 40 in the direction along the second reference axis Y. The same goes for the relationship between the size of the casing 40 in the direction along the first reference axis X and the size of the casing 40 in the direction along the third reference axis Z.
In the first embodiment, the grip portion 40A in the casing 40 may be the center portion of the casing 40 when the casing 40 is divided into three in the direction along the first reference axis X. In this case, the first end portion 40B is a portion including the end on the first positive direction X1 side of the three divided portions, and the second end portion 40C is a portion including the end on the first negative direction X2 side of the three divided portions.
In the embodiments, the configuration of the vibrating body is not limited to that described above. For example, the vibrating body may use vibration by a motor, or may include a piezoelectric element.
For example, in the first embodiment, the first vibrating body 51 only needs to generate a first sense of force in the first direction. Hence, the first vibrating body 51 need not be configured to generate a first sense of force in all six directions. That is, for example, the first vibrating body 51 may be capable of generating a first sense of force only in the third positive direction Z1 and the third negative direction Z2. Alternatively, for example, the first vibrating body 51 may be capable of generating a first sense of force only in the third positive direction Z1, the third negative direction Z2, the second positive direction Y1, and the second negative direction Y2. That is, each vibrating body only needs to achieve the direction of the sense of force that needs to be generated when executing the first control. The same goes with the other embodiments.
In the embodiments, the arrangement of the vibrating bodies may be changed appropriately. For example, in the first embodiment, the distance from the center of gravity of the casing 40 to the first vibrating body 51 may be different from the distance from the center of gravity of the casing 40 to the second vibrating body 52. In addition, for example, in the first embodiment, the first vibrating body 51 and the second vibrating body 52 may be located away from the first reference axis X. In addition, for example, in the first embodiment, the first vibrating body 51 and the second vibrating body 52 may be incorporated in the grip portion 40A.
In the embodiments, the inclination sensor only needs to be able to detect the attitude of the handle, and is not limited to the three-axis acceleration sensor. For example, the inclination sensor may be a sensor using an infrared sensor, a magnetism sensor, or a gyroscopic sensor, as long as the attitude of the handle can be detected. Specifically, by using a plurality of these sensors, it is possible to detect the attitude of the handle by detecting the relative position from a reference point such as a charging stand. In addition, for example, the inclination sensor may be an image sensor. An image sensor may detect the attitude of the handle by performing image processing on data output by a camera.
In the embodiments, the control device may be incorporated in the head, or may be incorporated in the casing of the handle. Compared to the inside of the head, the casing of the handle is less likely to be affected by heat and vibration of the head. Hence, the casing of the handle is suitable for incorporating the control device.
In the embodiments, the control device only needs to be able to execute first control. Hence, for example, in the first embodiment, the control device 70 may be configured to execute only one of the rotation curbing control and the rotation promotion control. Further, the control device 70 may execute the first control for a purpose other than rotation curbing or rotation promotion.
In the rotation promotion control in the first embodiment, the control device 70 may execute the first control regardless of the pressure sensor 62. In the rotation promotion control, the first control only needs to be executed on condition that the attitude of the handle 20 is an attitude within a predetermined range. In addition, the attitude of the handle 20 within the predetermined range can be changed appropriately. For example, the condition may include that, in addition to the first reference axis X, the inclination of the second reference axis Y and the third reference axis Z also be within a certain range with respect to the axis along the direction of gravity.
In the rotation curbing control of the first embodiment, the control device 70 may execute the first control regardless of the pressure sensor 62. In the rotation curbing control, the first control only needs to be executed in a case where a change in the attitude of the handle 20 is detected by the inclination sensor 61. In addition, in the rotation curbing control, the first control may be executed on condition that a change in the attitude of the handle 20 is detected after there had not been a change in the attitude of the handle 20 for a certain time.
In the second embodiment, the control device 170 only needs to be able to execute the first control and the second control, and may repeat the first control and the second control alternately regardless of the attitude of the handle 120.
In the second embodiment, the third vibrating body 153 to the sixth vibrating body 156 may be omitted. In addition, the control device 170 may execute the first control by using, instead of the first vibrating body 151 and the second vibrating body 152, the third vibrating body 153 and the fourth vibrating body 154 as the first vibrating body and the second vibrating body.
In the second embodiment, the control device 170 may execute the first control by using, instead of the second vibrating body 152, the third vibrating body 153 as the second vibrating body, for example. In this case, with the first control, the hair dryer 110 gives the user a sense of force of rotation about an axis parallel to the third reference axis Z passing through between the first vibrating body 151 and the third vibrating body 153.
In the rotation curbing control in the third embodiment, the control device 270 may detect whether there has been a change in the attitude of the handle 220 on the basis of the inclination of the first reference axis X with respect to the axis along the direction of gravity.
In the fourth embodiment, the control device 370 may store, in the ROM, a plurality of programs that each execute the first control and the second control for fixed time periods. For example, if there are a plurality of programs having different time periods of executing the first control, the user can select one of the plurality of programs and execute it for guidance on brushing with different curl techniques.
In addition to the first control and the second control of the fourth embodiment, the control device 370 may execute control for generating a sense of force from each vibrating body in a direction generating a sense of force about at least one of the second reference axis Y and the third reference axis Z. By adding such control, guidance on a more complex operation can be given to the user's hand.
In the fourth embodiment, the control device 370 may omit the second control. That is, the control device 370 may be configured to execute only the first control. In this case, the control device 370 only needs to execute the first control for just a predetermined time.
In the rotation promotion control of the fifth embodiment, the control device 470 only needs to execute the first control on condition that the change in the attitude of the handle 420 is a predetermined change. The predetermined change is not limited to the example of the fifth embodiment. For example, the control device 470 may execute the first control on condition that the attitude of the handle 420 changes only within a predetermined range in a certain time after closing the clip 431. In this case, for example, the control device 470 can execute the first control to give guidance on starting curling of the eyelashes when the attitude of the handle 420 does not change for a time during which it can be confirmed that the user has nipped the base of the eyelashes by the clip 431.
In the above embodiments, the handle may be applied to other products operated by being gripped by the user's hand and fingers. For example, the handle may be applied to home haircut equipment such as an electric hair clipper. The handle is particularly suitable for a product in which a head coupled to the handle is directly brought into contact with the user's body or output is made toward the user's body from a head coupled to the handle.
In addition, the handle can be used individually. For example, the handle can be used to guide the rotation direction in which the user should move the arm when performing gymnastics or rehabilitation.
In the embodiments, the control device is not limited to those including a CPU and ROM and executing software processing. For example, the control device may include a dedicated hardware circuit (such as ASIC) for executing hardware processing on at least a part of the processing executed by software in the above embodiments. That is, the control device may have any of the following configurations (a) to (c). (a) The control device includes a processing device that executes all of the above processing according to a program and a program storage device such as a ROM for storing the program. (b) The control device includes a processing device that executes a part of the above processing according to a program, a program storage device, and a dedicated hardware circuit that executes the rest of the processing. (c) The control device includes a dedicated hardware circuit that executes the above processing in its entirety. Here, there may be a plurality of the software execution apparatus including the processing device and the program storage device, and the dedicated hardware circuit.
In the above embodiments, the program and data necessary for the control device to execute each control may be updated from the outside. For example, in the first embodiment, the control device 70 may include a storage device. Then, when data for controlling the vibration pattern of the first vibrating body 51 is input to the control device 70 from an external device, the storage device may store the new data.
When the configuration of the vibrating body is changed as in the above modification, the case of the first vibrating body and the case of the second vibrating body 52 may be the same. That is, the handle may be incorporated in the casing, and there may be provided a haptics portion that gives the user gripping the casing a sense of force that feels as if the casing is rotating. In addition, the control device may be configured of a plurality of devices, and each device may control a single vibrating body. That is, the handle only needs to include a control unit that controls the haptics portion described above. Thus, the handle only needs to include a casing, a haptics portion incorporated in the casing, and a control unit. Then, the control unit only needs to be able to control the haptics portion so as to give the user gripping the casing a sense of force that feels as if the casing is rotating.
In the hair dryer 110 of the second embodiment, in order to give the user a sense that feels as if the hair dryer 110 is rotating alternately, the first vibrating body 151 and the second vibrating body 152 do not necessarily have to be incorporated in the handle 120. For example, the fifth vibrating body 155 and the sixth vibrating body 156 may be used as the first vibrating body and the second vibrating body. That is, the first vibrating body and the second vibrating body may be incorporated in the head 130.
In the hair styling iron 210 of the third embodiment, in order to give the user a sense that feels as if the hair styling iron 210 rotates about the first reference axis X, the first vibrating body 251 and the second vibrating body 252 do not necessarily have to be incorporated in the handle 220. For example, the first vibrating body 251 and the second vibrating body 252 may be incorporated in the first nipping portion 231.

Technical ideas conceivable from the above embodiments and modifications are added below.

### <Note 1>

A hair dryer including:
a first vibrating body;
a second vibrating body;
a handle having a casing that a user can grip with the hand and fingers;
a head coupled to the handle and capable of blowing air; and
a control device capable of generating a first sense of force in a first direction by controlling a vibration pattern of the first vibrating body, and capable of generating a second sense of force in a second direction by controlling a vibration pattern of the second vibrating body, in which
the control device is capable of executing
first control of controlling the vibration pattern of the first vibrating body and the vibration pattern of the second vibrating body so that the first direction and the second direction are different directions, and an imaginary line headed toward the first direction from the first vibrating body and an imaginary line headed toward the second direction from the second vibrating body are not located on the same straight line, and
second control of controlling the vibration pattern of the first vibrating body and the vibration pattern of the second vibrating body so that the first direction is a direction opposite to that in the first control, and the second direction is a direction opposite to that in the first control.

### <Note 2>

A hair styling iron including:
a handle that has a first casing, a second casing, and a shaft body connecting the first casing and the second casing in a rotatable manner, and is grippable by a user with the hand and fingers:
a head that has a first nipping portion coupled to the first casing and a second nipping portion coupled to the second casing, and is configured to nip the hair;
a first vibrating body and a second vibrating body incorporated in the first casing or the first nipping portion;
an inclination sensor that detects an attitude of the handle; and
a control device capable of generating a first sense of force in a first direction by controlling a vibration pattern of the first vibrating body, and capable of generating a second sense of force in a second direction by controlling a vibration pattern of the second vibrating body, in which
the control device
is capable of executing first control of controlling the vibration pattern of the first vibrating body and the vibration pattern of the second vibrating body so that the first direction and the second direction are different directions, and an imaginary line headed toward the first direction from the first vibrating body and an imaginary line headed toward the second direction from the second vibrating body are not located on the same straight line, and
executes the first control in a case where a change in the attitude including movement of the first vibrating body in the second direction and movement of the second vibrating body in the first direction is detected by the inclination sensor.

### REFERENCE SIGNS LIST

10 shaver
20, 120, 220, 320, 420 handle
30, 130, 230, 330, 430 head
31 blades
40, 140, 240, 340, 440 casing
40A grip portion
40B first end portion
40C second end portion
51, 151, 251, 351, 451 first vibrating body
52, 152, 252, 352, 452 second vibrating body
61, 161, 261, 461 inclination sensor
70, 170, 270, 370, 470 control device
110 hair dryer
210 hair styling iron
231 first nipping portion
232 second nipping portion
310 hairbrush
331 brush
410 eyelash curler
431 clip

1. A handle comprising:
a casing that is grippable with a hand and fingers of a user;
a first vibrating body in the casing;
a second vibrating body in the casing; and
a controller configured to generate a first sense of force in a first direction by controlling a vibration pattern of the first vibrating body, and to generate a second sense of force in a second direction by controlling a vibration pattern of the second vibrating body,
wherein the controller is configured to control the vibration pattern of the first vibrating body and the vibration pattern of the second vibrating body so that the first direction and the second direction are different.

2. The handle according to claim 1,
wherein an axis passing through a center of gravity of the casing is a first reference axis and an axis orthogonal to the first reference axis is a second reference axis,
wherein a size of the casing in a direction along the first reference axis is larger than a size of the casing in a direction along the second reference axis,
wherein the first vibrating body and the second vibrating body are on opposite sides of the second reference axis and are along the first reference axis when viewed from the center of gravity, and
wherein the first direction and the second direction are orthogonal to the first reference axis.

3. The handle according to claim 2,
wherein the casing comprises a grip portion including the center of gravity, a first end portion adjacent to a first end of the grip portion, and a second end portion adjacent to a second end of the grip portion,
wherein the first vibrating body is in the first end portion, and
wherein the second vibrating body is in the second end portion.

4. The handle according to claim 1,
wherein an axis passing through a center of gravity of the casing is a first reference axis and an axis orthogonal to the first reference axis is a second reference axis,
wherein a size of the casing in a direction along the first reference axis is larger than a size of the casing in a direction along the second reference axis,
wherein the first vibrating body and the second vibrating body are on opposite sides of the first reference axis and are along the second reference axis when viewed from the center of gravity, and
wherein the first direction and the second direction are orthogonal to the second reference axis.

5. The handle according to claim 2, wherein a distance from the center of gravity to the first vibrating body is equal to a distance from the center of gravity to the second vibrating body.

6. The handle according to claim 4, wherein a distance from the center of gravity to the first vibrating body is equal to a distance from the center of gravity to the second vibrating body.

7. A shaver comprising:
the handle according to claim 1;
a head coupled to the handle and comprising blades configured to cut hair; and
an inclination sensor configured to detect an attitude of the handle,
wherein the controller is configured to control the vibration patterns when the detected attitude of the handle is within a predetermined range.

8. The shaver according to claim 7, wherein the controller is configured to control the vibration patterns such that a difference between a rate of change of the first vibration pattern and a rate of change of the second vibration pattern exceeds a predetermined threshold.

9. A hair dryer comprising:
the handle according to claim 1; and
a head coupled to the handle and configured to blow air,
wherein in a first control pattern, the controller is configured to generate the first sense of force in the first direction and to generate the second sense of force in the second direction, and
wherein in a second control pattern, the controller is configured to generate the first sense of force in a direction opposite to the first direction and to generate the second sense of force in a direction opposite to the second direction.

10. The hair dryer according to claim 9, further comprising an inclination sensor configured to detect an attitude of the handle,
wherein the controller is configured to alternately repeat execution of the first control pattern and the second control pattern when the detected attitude of the handle is within a predetermined range.

11. A hair styling iron comprising:
the handle according to claim 1;
a head coupled to the handle and comprising a first nipping portion and a second nipping portion configured to nip hair; and
an inclination sensor configured to detect an attitude of the handle,
wherein the controller is configured to control the vibration patterns when a change in the attitude including movement of the first vibrating body in the second direction and movement of the second vibrating body in the first direction is detected by the inclination sensor.

12. A hairbrush comprising:
the handle according to claim 1; and
a head coupled to the handle and comprising a brush configured to brush hair.

13. The hairbrush according to claim 12,
wherein in a first control pattern, the controller is configured to generate the first sense of force in the first direction and to generate the second sense of force in the second direction,
wherein in a second control pattern, the controller is configured to generate the first sense of force in a direction opposite to the first direction and to generate the second sense of force in a direction opposite to the second direction,
wherein the controller is configured to execute the second control pattern only for a predetermined time, and
wherein the controller is configured to execute the first control pattern and the second control pattern in a predetermined order.

14. An eyelash curler comprising:
the handle according to claim 1;
a head coupled to the handle and comprising a clip configured to nip eyelashes; and
an inclination sensor configured to detect an attitude of the handle,
wherein the controller is configured to control the vibration patterns when a change in the detected attitude of the handle is a predetermined change.

15. A handle comprising:
a casing that is grippable by a hand and fingers of a user;
a haptics portion in the casing; and
a controller configured to control the haptics portion so as to give the user gripping the casing a sense of force that feels as if the casing is rotating.
